(19) United States
(12) Patent Application Publication
(10) Pub. No.: US 2014/0006061 A1
(43) Pub. Date: Jan. 2, 2014

(54) METHODS AND APPARATUS FOR PROCESSING INSURANCE CLAIMS

(71) Applicant: Advance Response, LLC, (US)

(72) Inventors: Timothy Watanabe, San Jose, CA (US); Kenneth Poray, Point Pleasant Beach, NJ (US); Craig So, San Jose, CA (US)

(73) Assignee: ADVANCE RESPONSE, LLC, San Jose, CA (US)

(21) Appl. No.: 13/715,809

(22) Filed: Dec. 14, 2012

Related U.S. Application Data
(60) Provisional application No. 61/570,828, filed on Dec. 15, 2011.

(51) Int. Cl. G06Q 40/08

(52) U.S. Cl. CPC G06Q 40/08
USPC 705/4

(57) ABSTRACT

Methods and apparatus for automated insurance claims and eligibility/benefits communication, audit, and research are described. This application relates to methods and apparatus for automated insurance claims and eligibility/benefits communication, audit, and research. These methods include processing an insurance claim, comprising creating a claim for payment of medical services for a patient from a medical provider, submitting the payment claim to an insurance carrier, adjudicating the claim; and submitting the payment to the medical provider, wherein during the process of adjudicating the claim, data is collected about the efficiency of the payment process and it is reported back to the medical provider and used to improve the information used to create the claim. Other embodiments are described.

### CROSS-REFERENCE TO RELATED APPLICATION

This application claims priority of U.S. Provisional Application Ser. No. 61/570,828 filed Dec. 15, 2011, the entire disclosure of which is incorporated herein by reference.

### FIELD

This application relates generally to methods and systems for processing insurance claims. In particular, this application relates to methods and apparatus for automated insurance claims and eligibility/benefits communication, audit, and research.

### BACKGROUND

Health insurance claims take a standard path from submission and adjudication to payment and notification. At each step of the path, there are variables; however, most health insurers follow the same basic procedures. Claim submission is the first part of the claim processing path. Claims are submitted for each medical service provided. Depending on the type of insurance plan and if the provider of services is in-network or out-of-network, the claim may be submitted by the provider or the patient. In the adjudication process, the insurer determines who is responsible for payment and the amount. Providers may submit charges for any amount, but claims are often adjudicated to pay just the allowed amount. If the insurance plan has a co-insurance provision, a percentage of the claims are paid to the provider and the patient is responsible for paying the rest. Adjudication is often electronic but may require manual intervention by a claims processer, depending on the service, amount of the submitted claim or if the claim is incomplete. After claims adjudication, the payment is sent to the provider or patient, as applicable. The claim may be denied, in which case no payment is sent. However, in most cases the payment is reimbursed directly to the provider through an electronic transfer and by check to the patient. The patient receives an explanation of benefits statement upon adjudication of a claim. The explanation of benefits displays claims details, including how the claim was paid, patient balance, the date of service and the procedure or service code of the service.

### SUMMARY

This application relates to methods and apparatus for automated insurance claims and eligibility/benefits communication, audit, and research. These methods include processing an insurance claim, comprising creating a claim for payment of medical services for a patient from a medical provider, submitting the payment claim to an insurance carrier, adjudicating the claim; and submitting the payment to the medical provider, wherein during the process of adjudicating the claim, data is collected about the efficiency of the payment process and it is reported back to the medical provider and used to improve the information used to create the claim.

### DETAILED DESCRIPTION

The following description supplies specific details in order to provide a thorough understanding. Nevertheless, the skilled artisan would understand that the apparatus and associated methods of making and using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry. For example, while the description below focuses on using the communication system for processing insurance claims, it could be used in and applied to other types of transactions, like insurance or mortgage servicing transactions.

Some embodiments of the methods and apparatus for processing insurance claims are described below.
Allows for customized/automated communication for each entity. Customized communication includes automating communication channels and paths for phone system integration/navigation/transcription, hold time management via agent opt-in, web service integration, data aggregation, data rationalization, data presentment, and EDI system integration and transcription.
Integrates with both the service provider and insurance company (payer) systems.
Audits the data from 2 or more systems and reports back to agents
After completing the audit, the system prioritizes, highlights, and presents data in the way that's best suited for each entity
The system coordinates/synchronizes electronic and human resources, providing automated and facilitated agent to agent, agent to system, system to agent and system to system communication.
The system can do cross system/function lookups. For instance, if Medi-Cal eligibility indicates that a particular patient's insurance is Blue Cross if the Date of Service is after Oct. 1, 2010 and the provider's billing system knows the Date of Service is Mar. 1, 2011, the system can look up claims and eligibility on the Blue Cross electronic or voice sites.
The system can do lookups for multiple payers. For instance, a person may have a primary, secondary, and tertiary insurance plan. The system can look up claims/eligibility for all associated plans.
The system can fill out template forms. For example, a claims appeals form.
The system is a Software As A Service platform.
The system provides integration of data in and out of provider's systems (i.e. Meditech, AllScripts, Epic, McKesson, etc)
   Examples include notes or status updates, rebills, etc.
   Other examples include automatically updating a system (examples include but are not limited to: a provider's billing system or payer's web site) based on business rules. For example, a business rule can be created where if a payer's web site indicates a subscriber's policy has been cancelled, that the provider's billing system Is updated accordingly.

Description—Including the Manner and Process of Making/Using it
Allows for storage of customized communication procedures for each entity
   Insurance Companies
      Preferred EDI communication time frames
      Preferred internet protocol time frames
      Preferred internet protocol workflows
      Preferred IVR communication time frames
      Preferred IVR call paths/work flows
         An example of a preferred call time is when a payer has less call volume on any given day/time frame of the week. For instance, lets say from 4-6 pm, their call volume is reduced. This would be the time call centers would prefer to receive calls. By indicating these time frames, the provider agent can be presented with the option of calling now or have a “call back” at the preferred time frame.
      Preferred communication mechanism prioritization (for instance, web first followed by phone)
      Data display
         Payers can define what fields/data to display in which order
         For instance, the payer may want to see the claim number 1^{st} followed by the provider's question next.
   Service Providers
      Contractual or policy data
         For instance, a service provider may have a “90 day” agreement with a payer in which the service provider must file an appeal once notified of a rejected claim.
         Another example is discounts to specific payers. For example, a provider may have a 5% contractual discount with Blue Cross of California while the same provider may have a 15% contractual discount with Blue Shield of California.
         Another example is some procedures may be “free of charge”. For instance, blood draw fees are free of charge
      Field selection and audit criteria
         For instance, compare the “total charges amount” field from the provider's system to the “total amount billed” field from the payer's web site. Also, indicate when the two amounts differ by more than $1.00.
      Search codes/messages
         Comprises of a customized listing of codes, messages, and/or other form of criteria.
         For instance, each payer's web site has custom html page codes. A <p class=\“bold\”> could mean the field could be a title like “Patient Name”. The associated value/message could be something like <p> or <span class=\“medicaremainresult\”>. In another example <h5> could be used for a header.
         The system searches for headers, titles, and their associated values. For instance, in the section of the web page with the header “Claims Details”, the title could be “patient name”, with the patent's name being “Joe Smith”.
         As information is generally displayed in a “left to right” and/or “top to bottom” fashion, the system's logic/algorithms find header, title, and value codes/messages based on “left to right” and/or “top to bottom” formatting.
         For example, if the system reads the web page as a normal human would, it would read the 1^{st} header and remember it. It would then remember the 1^{st} title and remember that. Upon reading the 1^{st} value, it would know that value was associated with the latest header and title. Accordingly, it would map the latest header and title to the associated, normalized tables and columns in the database, and then write the value to the corresponding table/column.
         The system will keep looping through the HTML page remembering the latest header/title pair and, upon finding a value, map that header/title pair to the DB's table/column pair and insert the value accordingly.
         Further, the system can combine or split values found on web pages and insert them into DB fields accordingly.
         Comprises of a search function that matches the listing of codes, message, and/or other criteria to insurance company data.
         Also includes additional searches based on returned data. For instance, if a claim is not found for the NPI (National Provider Identification Number) provided, look for the same claim (for instance, date of service, subscriber ID, and billed amount) for ALL of the other NPIs for that organization. An example is a hospital that has many doctors. It's possible that the billing agent (or payer agent) typed in the wrong doctor's (NPI). In this case, we would search the payer web site for each and every NPI (doctor) associated with the hospital to see if we can find the claim if filed under another doctor (NPI).
         Comprises of an identification function indicating which fields/items match the search criteria and/or which items do not match (are discrepant)
         For instance, looking line by line in the payer's system for codes/messages indicating the provider needs to take action. An example for a criteria is any line item in the payer's system where the paid amount is zero.
         Normalizing these messages. For instance, multiple payers may have slightly different codes/message indicating the same course of action for a provider.
         Highlighting each line where a customized code/message/criteria is found.
      Key dates/fields
         For instance, a contract between a payer and service provider may specify that the service provider must file an appeal within 90 days from being notified of the payer's rejection of the claim. The notification date, in this example, is posted on the payer's web site in the “finalized date” field.
         Examples include timely filings and appeals dates/deadlines.
      Calculations
         In the “appeals” example above, calculating and reporting the number of days remaining prior the expiration of the 90 days. For instance, there may be 1 day remaining before the appeals deadline.
         Another example is calculating the amount to be billed. For instance, for a billed amount of $100, the insurance company may be required to cover 80% after a $20 co-pay. The bill to the insurance company could be 80% of $80.00 or ($64.00).
         Another example is secondary, tertiary insurance, as well as patient/self pay. Calculating the proper amount to bill each party based on coverage/eligibility and any previously paid amounts (such as deductable) and presenting the proper billing breakdowns.
      Match logic
         The determination of the logic that determines which claims from a search match the claim to be researched. Examples include matching service rendered dates within 1 business day or matching the amount billed fields within 1 dollar.
      Prioritization
         Prioritization of work flow based on search and audit criteria. As an example, if a customized message is found indicating provider action, make it a high priority. If it's past the timely filing date, make it a low priority. If it doesn't match a search code/message and is not past the timely filing date, make it a medium priority. If the appeals deadline is within 14 days of today, make it a high priority.
      Highlighting/marking
         Bringing the user's attention to particular items of interest.
         For instance, a user may want to have an indication of when the provider's and payer's respective billed amounts don't match.
         Another example is the provider agent may want a line item highlighted if the paid amount is zero.
         Another example is specific revision, procedure, denial, reason, or explanation of benefits codes.
         For instance, if one of a specific list of revision/procedure codes is found on any line item of a claim's on the payer's web site (i.e. 274, 276, or 283), color code the entire item green. If the revision/procedure code matches 321, 345, 456 or 834, color code the entire line item. Another example is if the denial/reason/explanation of benefits code matches something like “service is not a benefit”, highlight that entire line item red.
      Question input
         The provider will be able to enter/record their specific questions pertaining to a given claim or eligibility request. The question can then be stored and later displayed to both the payer and provider agents as needed.
Billing
   Types include uploaded line items, Web service or EDI lookups, phone calls made, minutes for phone calls, data presentment, and deflections (charging based on an electronic lookups that don't result in a phone call made).
   The ability for a payer to pay a portion or the entirety of a service provider's bill. This can be based off of provider performance criteria.
Community
   Compiling a list of the most successful of the above and recommending those.
Secure data and communication mechanisms
Data and/or content to be sent and received via a combination EDI, IVR, and/or internet protocol integration
Data to be rationalized/normalized and stored the data in a database
Applying the rules/preferences in order to determine the best mode of communication
Applying the rules/preferences in order to determine priorities
Applying the rules/preferences in order to determine items to flag or highlight
Applying customized workflows for the desired mode of communication
Communicating the key portions of the content via the desired mode of communication and work flow
Receive correspondence back from the recipient entity
Apply the received correspondence to the originating entities preferred custom communication interface
Record/log all activity/correspondence
Perform requested audits
Perform match analysis with confidence rating
Present data to entities as requested
   For instance, present web, voice, or EDI information to the agent in a friendly format.
   This can include the presentment of multiple claims or eligibility items to a human agent in one screen.
   This can also include showing either customized data presentation or identical/mirrored data. In this later case, the payer and provider agents would literally be “on the same page” and see the same information, including the specific question (if provided) that the provider entered/needs answered.
Perform coordinated or alternate searches as necessary
   For example, if a BCCA claim is not found, try an “out of state” next. If still not found, try Blue Shield of California.
   Further, after the claim is found, perform the eligibility research as well as the benefits research.
   Another example is if a claim is not found for a specific date of service. In this case, extend the dates of service to be one day prior and one day after the noted date of service.
   Another example is if a claim is not found for a specific dollar amount. In this case, possibly still search on the subscriber ID, date of service, but don't include the billed amount in the search. This helps find claims where the billed amount was mistyped into the payer or provider system.
Ability to create custom disposition and note taking templates
   Dispositions can be things like paid or rejected or past timely filing
   Each disposition can have templates for filling in text. For example, “Per the [TMHP] web site, claim number [123456789] was PARTIALLY PAID”. Users can create as many disposition templates as needed. Items in square brackets would be filled in from the data gathered.
   Detailed notes—For example a specific line item within a claim, may need additional details provided beyond the disposition text. A template similar to the above could be created. For instance, “Reason code [297] was given with a description of [This service cannot be rendered from this provider type].”
   Simply selecting a disposition from a drop down would generate the disposition template text. Further, clicking on one or more detailed line item(s) would result in the generation of more detailed, supporting text.
Creation of activities
   Custom or generic, an activity may be something like “Add Note” which would automatically add a note or provide an audit trail to the system of record. A corresponding button, radio button, drop-down list, etc would be presented to the agent that would perform the requested task.
      Another example would be “Submit Appeal”.
Integration into systems
   Import and Export functionality into provider, payer, or other systems. Can be provided via Application Program Interface (API) and/or custom parsers. Formats may include: xml, csv, etc.
      This includes APIs where Advance Response (AR) integrates into payer or biller systems as well as APIs where payers, billing system vendors, or providers can integrate with Advance Response.
         An example of where a payer would integrate with Advance Response's API is a self service claims API.
         Advance Response (AR) would publish an API indicating how the two voice/phone systems would interact with each other.
         For instance, the Advance Response system would dial a special phone number that the payer would provide.
         Once the payer's system answers the phone call, they can automatically request information from AR system by entering 2 digit touch tone codes followed by the “#” key.
         For example, the payer's voice system could automatically press “01” and then “#”. Per the API documentation, the AR system would know that the provider's NPI is requested. It would then lookup that request and automatically enter it into the payer's voice system, followed by the “#” key.
         In turn, the API and it's accompanying documentation would indicate requests and responses from AR to the payer's system. For instance, once the payer's system has all of the search information it needs from AR, the payer system can enter “00” followed by “#”. The AR system can then begin requesting information in the same way. For example, entering “44” and then pressing “#” could request the check number from which the claim was paid. The payer system would respond accordingly.
         The systems would keep interacting this way until all of the data is transferred.
      Another example is a similar web based Application Program Interface (API) where the payer's and AR's web systems would request and respond with the required information.
         For instance, an XML interface could be utilized where AR sends the payer's API credential/authentication/security information. Upon successful authentication, the payer system can send XML back indication authentication successful. AR can then send XML with the search information needed (for instance, subscriber ID, date of service, billed amount, etc). The payer can then respond with the appropriate claim, eligibility, explanation of benefits, etc information.
         The 4010 or 5010 XML Schema standards for 270, 271, 276, 277, 835, etc transactions will be leveraged.
   This allows for white labeling/branding
   Dispositions and notes are examples of functionality
Branding (White labeling)
   The ability for other companies to utilize components of the system or the system in it's entirety with the licensing company's logos, branding, look and feel.
Advertizing/Messaging
   Use of screen space or phone time to deliver advertisements or messages
Scheduling/scheduler
   Coordination of integration/communication components such as the voice, web, and EDI preferred paths
   The scheduler will utilize the preferences noted above
      For instance, if a payer's call center is closed, alert the provider's agent accordingly
   Time based triggering mechanism
      Some tasks require activation or triggering at specific times of the day. For instance, a payer's agents may have low phone traffic at a particular time of the day. The Advance Response system can offer the provider's agent the option for return call times at the times of day that are off-peak hours for the payer. If the provider's agent selects one of the scheduled return times, the Advance Response system can trigger calls during the selected/preferred times. The Advance Response system can also batch up and present a series of claims or eligibility requests per call.
   To and from entity attributes/status
      For instance, if the “to” entity's web site is down, the AR web integration function will notify the scheduler that the entity's web site is down.
      The scheduler can then take the appropriate action. For instance, instead of launching thousands of web requests to that entity, possibly trying one every 10 minutes until the web site is available again. Once available, launch a larger volume of requests.
      Similarly, controls are put in place for the “from” entity. For example, if the “from entity” changes it's web password and does not update the AR system, the web integration function of the AR system will notify the scheduler that the password is no longer valid. The scheduler could then take the appropriate action. For example, not launch any more web inquiries from the specific “from” entity to the specific “to” entity (who's password has changed) until the password is updated.
      Another example is call center hours of operation.
Item Audit
   Each claim, eligibility, and/or benefits item will go through a field by field, line by line, and item by item audit based on the criteria detailed above.
   Discrepancies and/or matches in fields, line items, and/or items will be prioritized, highlighted and/or marked/indicated according to the criteria based on the audit results.
      For instance, if one of a specific list of revision/procedure codes is found on any line item of a claim's on the payer's web site (i.e. 274, 276, or 283), color code the entire item green. If the revision/procedure code matches 321, 345, 456 or 834, color code the entire line item. Another example is if the denial/reason/explanation of benefits code matches something like “service is not a benefit”, highlight that entire line item red.
   Based on discrepancies, follow-on actions may also occur. For instance, filling out and/or submitting subsequent insurance forms in order to rectify the discrepancy.
Phone Capabilities
   Ability to automatically place outbound calls and receive inbound calls
   Ability to apply voice prompts and/or touch tone responses to interact with and navigate IVRs
   Hold time can be reduced and/or eliminated based on call recipient's interactions.
      For instance, a payer agent can receive an Advance Response phone call with optional screen pop with questions. When the payer agent has completed their research of the claims, they could press “1” on their telephone keypad when they are ready to talk or chat with the provider agent. Upon pressing “1”, the provider agent would be contacted. As such, the provider agent wouldn't experience any “hold time”.
   Ability to record agent or IVR spoken interactions
      Examples include whole call recording and the recording of specific data being played back
   UI to play back recordings and perform appropriate actions/activities
      Example, some insurance companies provide “self service IVRS”. These are phone systems that will request information from the caller and automatically provide information back to the caller via voice/phone. The solution can navigate the payer's IVR, automatically answering the IVR's questions, and record the information that the payer's IVR returns. The solution can then present those saved recordings in a UI to the agent. The agent can then click to hear the IVR's information without having to navigate the IVR themselves. Further, as the voice technology is integrated with notes and actions/activities, users can then take the next appropriate action after listening to the requested information.
Chat Capabilities
   When determined to be the preferred mechanism of communication, chat can be used
   Chat includes standard or customized displays of multiple claims/eligibility requests and questions. See batch feature above.
Data entry into forms
   Ability to take stored data and enter them into forms to be used/submitted electronically or otherwise. For instance, the CMS 1500 form. The form can be for print for hard copy submission or vi electronic means (web or EDI for example) for electronic submission. An example of a form is an appeals submission.
Admin
   Sign up—companies can sign their company up to start utilizing AR system via the web as well as administer the following
   Add/remove users
   Password maintenance
   Creating/Editing business rules including prioritization, highlighting, match logic, etc
   Key dates/deadlines. For instance appeals and timely filings deadlines.
   Billing system utilized.
   Contractual Agreements such as discount rates and or specific procedure or bundled code pricing.
   Company holidays, hours of agent availability, hours of IVR phone system availability, hours of web service availability, etc.
System Audit Trail
   Each correspondence/interaction is tracked
   Each VXML is unique and stored
Reports
   Some examples include but are not limited to: Call deflection rates, Performance Levels (see below), periodic claims/eligibility reports
      Periodic Claims/Eligibility are reports that can run, for instance, daily, weekly or monthly. They can perform an audit of all claims or eligibility activity for a medical practice/entity. For instance, let say there's a doctor's office that is in a rural part of the country that does not have internet access. The system can perform a weekly check of all of the claims filed by that entity and then fax (see below) the report back to the doctor's office. The report could indicate the status and appeals deadline of each claim submitted by that particular office. The report could also provide insights into each specific denial.
Eligibility/Benefits, find out coverage/specifics, apply those to collectable amounts.
   See calculations above
Software-as-a-service platform with functions and services necessary for receiving or sending text, audio, or visual content, leveraging, where appropriate, interactive phone communication through speech or touchtone recognition, or text-to-speech playback. The apparatus enables users to create or customize templates specific to their respective applications.
Web to phone feature and Application Program Interface (API)
   For instance, a payer can put a “call now” button in the provider's or member's section of web site. This “call now” button would send the IVR navigation information to the Advance Response system. The Advance Response system would call a predetermined phone number to the payer and enter in the information sent (if any) into the payer's IVR, navigating accordingly.
Batching
   Multiple claims or eligibility/benefits can be batched into one call or communication method (such as chat)
Performance Levels/Reports
   Provider performance levels
      For instance, how fast return phone calls and/or chats are answered.
      Another example is electronic resolution rates. These are items that are resolved without the need to make a phone call. AKA Deflection rates.
      Another example is how many times a particular provider or provider's agent calls on different types of claims and/or denial/reason/EOB (explanation of benefits) codes
   Payer performance levels
      For instance, how often a payer is prepared prior to making the return phone call.
      Another example is if the payer participates in the “no hold time” opt-in functionality or not
      Other examples include the number of follow ups to a payer prior to resolution and the length of time payers or payer agents keep provider agents on hold.
      Other examples include payer rating systems
         For example, provider agents can rate and provide feedback on payers and specific payer agent performance. In this example, there can be a number of questions rating their performance. A simple example, for illustration purposes, is asking a yes or no question on if the payer agent called the provider agent prepared with the appropriate answers/questions needed.
         A “payer prepared” rating of 95% or higher could be a “platinum” rating, while a “payer prepared” rating of 90-94.9% could be a “gold” rating, and so on.
         Another example is “Certification Levels”. The more a payer, for example, integrates with the Advance Response system, the higher certification levels.
   Agent performance levels
      For example, the number of claims an agent works or resolves per day, week, or month.
Email and Fax
   The ability to Email or Fax information from or to other systems or users
Optical Character Recognition
   The ability to incorporate Optical Character Recognition into the system. For instance, receive an incoming fax or Adobe PDF file, optically recognize the characters/data/values, and insert the data into the AR database.
Complete View of Claims/Eligibility/Coordination of Benefits
   When a medical claim is created, often times, there are multiple insurance companies involved. Whether partially or fully paid by the primary insurance company, secondary insurance company, other insurance companies, the patient, written off, or allocated to other “buckets” such as denied or charity/financial assistance, the total amount needs to be accounted for to the penny. This feature shows a single view of the complete, up to date breakdown of all associated claims/dollars.
   It also incorporates the notes, work flow, and/or activities features above. For instance, a portion of the total bill may be a “write-off”. The user can identify the portion to be written off and select the “write-off” activity. The “write off” activity may make a note as well as send the system of record the corresponding transaction/status changes.
   Primary, secondary, tertiary, etc, plus patient responsibility will all portrayed as well as amounts such as total billed amount, contractual discounts, write-off amount, allowed amount, co-insurance, co-pay, deductable, paid amount, adjusted amount, remaining balance, patient responsibility and other characteristics like eligibility/verification/coverage on the date of service by each insurance company involved and benefit/coverage details.
      This feature also includes “in line edits”. For example, if the contractual agreement for a specific procedure code is “no charge” and the system administrator has not updated the contractual rules yet, the agent can adjust/edit the amounts accordingly and leave a note/audit trail. The system will record the audit trail and adjust the affected calculations accordingly.
      This feature also includes the integration of the “Contractual or policy data” data above as well as the algorithms needed to audit the correct aforementioned amounts.
         For example, the “Allowed amount”=“Total billed amount”−“Contractual Discounts”
         The patient's responsibility=Allowed amount−(Unpaid deductables and/or co-insurance)
         The primary payer's responsibility=Allowed amount−the patient's responsibility
         For the secondary payer, the same calculations hold true except that the secondary payer's responsibility starts from the patient's responsibility. In simple terms, in this case, the secondary payer (if the secondary insurance covers 80% of the patient's costs), would pay 80% of the patient's portion from the primary payer.
         The tertiary payer is similar to the secondary except it would pay the agreed portion of the patient's responsibility from the secondary payer.
   The complete view will also allow the user to view the details of each claim and/or eligibility/benefits details.
Historical View
   Often times, a medical service/procedure will go through a series of claims and eligibility research efforts. As information is gathered, a history is created. The history can include notes by agents, electronic images, adjustments, re-billing, re-submission of claims and/or information, etc. The system will aggregate all of the “historical” information associated with the claim/eligibility transactions and present a historical view of the activities associated with the claim/eligibility item.
   Example, the original claim may have been submitted by the primary payer on January 1. The primary payer denied it on January 15 for reason code 123 (missing information). The provider agent re-submitted the claim with missing on January 30. The primary payer paid all except $100 on February 15. The remaining balance was submitted to the secondary payer on February 28. The secondary payer denied the claim on March 15 as the patient did not have coverage for that procedure. On March 30, the billing agent discovered that the patient did have coverage but the procedure was inaccurately written. On April 15, the provider/billing agent resubmitted the claim to the secondary insurance company with the correct procedure code. On April 30, the remaining $100 was paid.
Claim/Check Reconciliation
   A claim or refund may be paid in part, in full, and/or sometimes inaccurately on one or more “bulk” checks. A bulk check is a check that has more than one claim or refund that is being paid in one check. In these cases, it's often difficult to account for the proper payments for claims/refunds across multiple adjustments on multiple checks.
   For instance, lets say there are 2 claims. The first claim is for $100 and the second claim is for $200. Both claims are paid at 80% on a check at the end of the month. So, a “bulk” check is written for $240 at the end of the month. As it turns out, the first claim was over paid by $20. The next month, there are 2 more claims. One for $300 and another for $400. Both of those claims are paid at 80% for a total of $560 with a reduction of $20 for the overpayment on the $100 claim.
   In this case, the $100 billed claim (that should have $60 paid) will have a payment of $80 on one check as well as an adjustment of −$20 on the 2^{nd} check.
   The system will be able to perform a claim to check reconciliation. It will be able to take each payment line item to each entity and total those line items up. It will then reconcile the line items and/or totals against various payment and/or refund checks. It will then identify/report which claims/refunds/line items have reconciled properly and which ones do not.
   Discrepant claims/line items will have the detailed claim or remittance information/explanations/explanation codes associated with it.
   Users will be able to create notes and make adjustments on screen as needed.
   An audit trail will be created including check/electronic funds numbers, etc.
   Results/adjustments/notes can be exported to external systems.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A method for processing an insurance claim, comprising:
creating a claim for payment of medical services for a patient from a medical provider;
submitting the payment claim to an insurance carrier;
adjudicating the claim; and
submitting the payment to the medical provider;
wherein during the process of adjudicating the claim, data is collected about the efficiency of the payment process and it is reported back to the medical provider and used to improve the information used to create the claim.
